(19) United States
(12) Patent Application Publication
(10) Pub. No.: US 2004/0115459 A1
(43) Pub. Date: Jun. 17, 2004

(54) Thermosetting resin-fiber composite and method and apparatus for the manufacture thereof

(76) Inventor: Giuseppi Cappi, Dalto, GA (US)

Correspondence Address: MILES & STOCKBRIDGE PC, 1751 PINNACLE DRIVE, SUITE 500, MCLEAN, VA, 22102-3833, US

(21) Appl. No.: 10/467,454

(22) PCT Filed: Feb. 7, 2002
(86) PCT No.: PCT/US02/03295

(30) Foreign Application Priority Data
Feb. 7, 2001 (IT) MI2001A000236

(51) Int. Cl. B32B 27/42

(52) U.S. Cl. 428/524

(57) ABSTRACT

The invention relates to composite materials of construction comprising thermosetting resins and fibrous reinforcing or filling agents therefore as well as methods for the fabrication thereof. The thermosetting resin composition comprises a particulate thermosetting phenol-aldehyde resin; and a particulate curing agent for the thermosetting resin. The curing agent is encapsulated in a water insoluble thermoplastic resin having a softening point higher than, (1) the melting point of said thermosetting resin and, (2) the temperature at which said thermosetting resin flows on a solid substrate. The encapsulating thermoplastic resin also is dissolvable in the thermosetting resin by heating said curing agent capable of curing said thermosetting resin upon melting of the encapsulating thermoplastic resin and release thereof. The phenol-aldehyde resin is a novolak formed by condensation of a phenol component comprising at least one bifunctional phenol with at least one aldehyde component represented by the formula: R—CHO wherein R represents a hydrogen atom, a methyl group or a halogenated methyl group.

### BACKGROUND OF THE INVENTION

1. Field of the Invention

The invention relates to composite materials of construction comprising thermosetting resins and fibrous reinforcing or filling agents therefor as well as methods for the fabrication thereof.

2. Description of the Prior Art

The manufacture of products, usually in the form of panels, rolls and the like, comprising glass fiber wool, rock wool, mineral wools and other inorganic fibers encased in matrices of resinous products, in particular, thermosetting resins, used in the building trades is well known.

Conventionally, these products are obtained by spraying onto the glass fiber, wool and the like an aqueous solution of phenol-formaldehyde resin, optionally with added urea, followed by crosslinking onto the fibers via a thermal process, so as to obtain a product having a compact insulating structure.

These just described conventional processes suffer from the drawback that they do not allow the control of the resin distribution onto the surface of the single glass fibers. Accordingly, the resin tends to be dispersed in an irregular or random way along the whole length of the fibers, contributing to stiffening them upon cross-linking to a rigid structure, such that they tend to break easily during the manipulation of the final products. The breaking of the fibers also lead to an adverse impact on the environment since the finely divided fragments, upon release into the environment, produce objectionable emissions. The phenomenon just described is made particularly severe by the fact that the hardening of the resin, necessary for mechanically linking together the individual fibers, results in the glass fibers being coated with multiple layers of hardened material, which make the product even more brittle and unpleasant to be handled. Moreover, these conventional processes suffer from the additional drawback of requiring excessive amounts of resin, thereby resulting in higher production costs for the products and higher disposal costs for the wastes, which are polluted by polymer decomposition and by other chemical products mixed therewith.

### SUMMARY OF THE INVENTION

The present invention relates to a new process and apparatus for manufacturing, e.g., heat and acoustic insulating products for building and industry in general. The method of the invention enables the preparation of novel thermosetting phenol-aldehyde, e.g., novolak, resin/fiber composites that are superior to those of the prior art in that the fibers thereof exhibit less rigidity and, therefore, breakability in the final product and require lesser amounts of the resin to form the matrix of the composite.

The invention relates also to, (1) a system or apparatus for carrying out the above-described invention, (2) the composition for preparing these products, and (3) the products so obtained.

### BRIEF DESCRIPTION OF THE DRAWINGS

FIG. 1 is an overall schematic view of the main steps of the process according to the invention:

FIG. 2 illustrates a schematic view of a detail of the system for binding resin onto the glass fibers

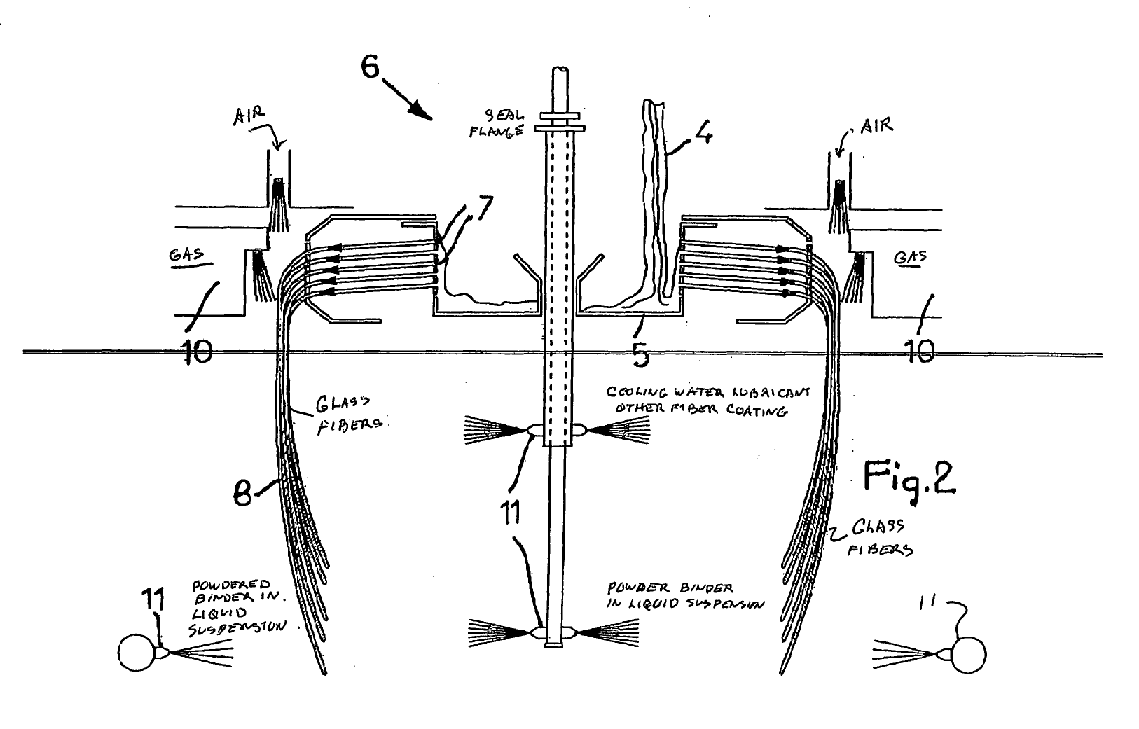

FIG. 3 illustrates an example of a product according to the invention; and

FIGS. 4 to 6 illustrate the steps of the process depicted in FIG. 2.

### DETAILED DESCRIPTION OF THE INVENTION

The foregoing and other objects are achieved by the process, apparatus, composition and products described herein below.

The present invention gives rise to an improved mechanical strength in the composite, due to the suppression of structural rigidities in the fibers themselves. In turn, the invention enables the use of smaller amounts of binding resin, thereby lowering the cost of the process for preparing the products as well as the cost of disposal of wastes.

These and other objectives, characteristics and advantages will be clearer from the following description of preferred embodiments of the present invention, and as illustrated in the drawings.

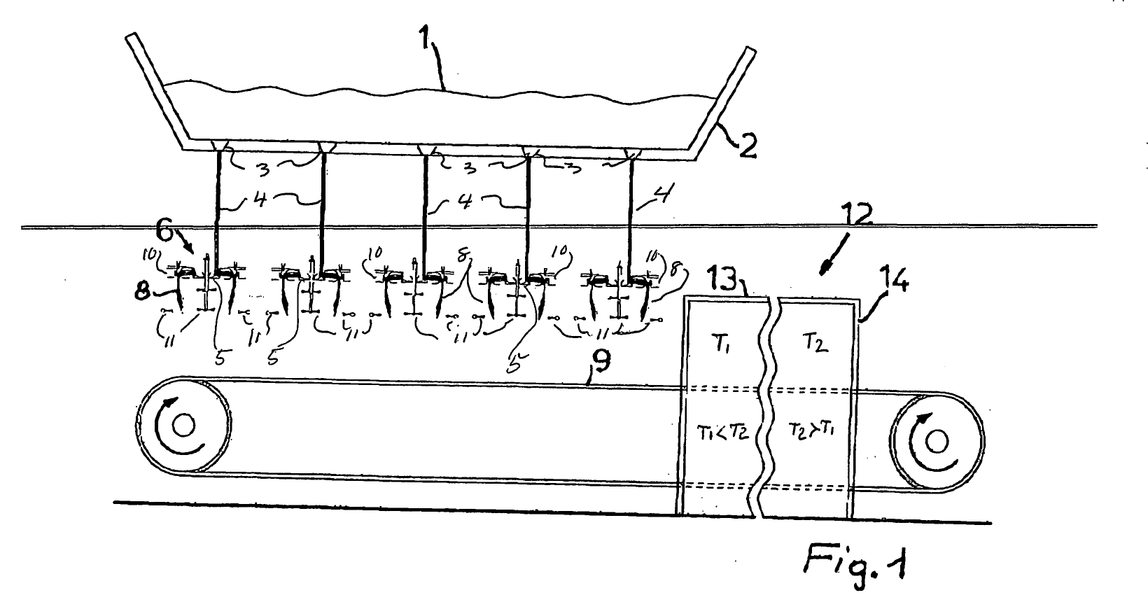

The process illustrated in FIG. 1 starts with the provision of a mass of molten material from which the fibers are to be prepared, in this example, a mass of molten glass 1, housed in a melting furnace 2 and made to pass through a die 3, so as to obtain a flow 4 of molten glass. This flow is then made to fall into the collecting tank 5 of a high-speed rotating fiberizing device or spinneret 6. Such a device has, on its outer surface, holes or openings 7 from which corresponding fibers 8 exit due to centrifugal force. The fibers are then deflected towards an underlying conveyor belt 9, through flame deflectors 10. On the conveyor 9, a mass or mattress 16 made of glass fiber wool is formed, whose thickness is controlled by the length of time the fiberizing devices 6 operate.

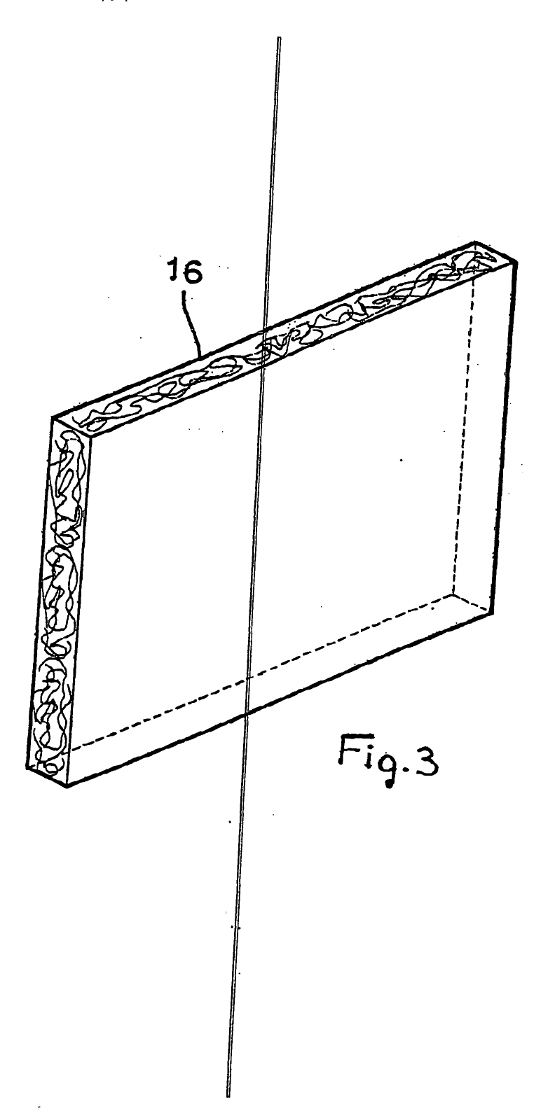

Prior to falling onto the belt 9, the glass fibers 8 are sprayed with a phenol-formaldehyde resin binder, in the form of a dry powder or of a dispersion of the resin powder in a water slurry, fed by sprayers 11. The particle material formed by the powder or slurry of the phenol-formaldehyde resin and by the cross-linking agent, also in the form of powder, is sprayed onto the forming glass fiber mass 8, and enclosed in the final structure which forms the mattress 16 (FIG. 3). The binder is delivered through a pipe 15 which has a double pipe construction, one inside the other to assure proper temperature control of the binder. The flow rates of the water and binder are controlled with pressure and flow controllers from a separate reservoir. The particle size of the catalyst resin powder preferably falls in the range from 0.5 to 2.5 μm.

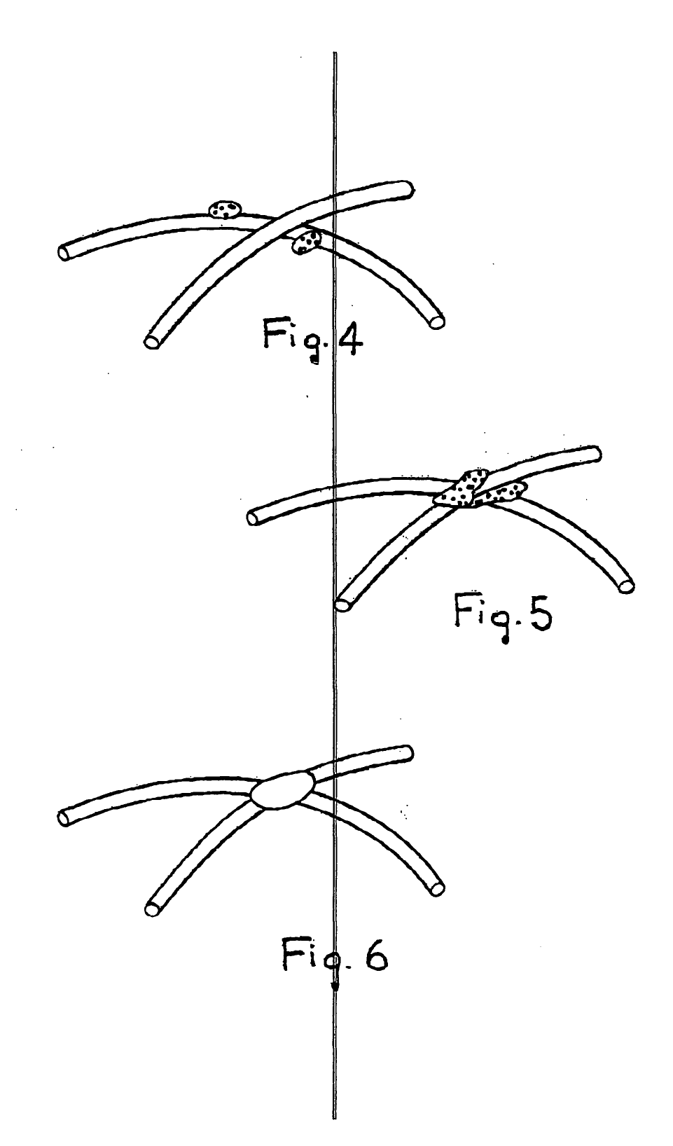

The so treated mattress 16 is then made to pass through a furnace 12 having two heating sectors 13, 14 having different temperatures, more precisely; through sector 13 for heating the phenol-formadehyde resin up to its melting temperature (at most 105° C.). The resin is molten in a mass that concentrates at most onto the knots while still in contact with the encapsulated catalyst particles (FIGS. 4-6). More particularly, the molten resin tends to concentrate, when migrating by surface tension, at the location of the knots or fiber-fiber junctions of the fiber mass. Preferably, an aqueous emulsion is added to the slurry, in small amounts (from 1.5% to 5%), based on the weight of phenol-formaldehyde resin, which alters the surface tension of the resin on the fibers, thereby enhancing the sliding of the resin toward the knots of the structure. The presence of the surfactant has the advantage of ensuring the formation of a thin layer of phenol-formaldehyde resin on the glass fibers, thus decreasing the brittleness of the glass fibers. The flow properties of the novolak can be further modified if necessary. For example, we have found that by alkoxylating some (5% or so) of the phenolic OH (with ethylene or propylene carbonate or ethylene or propylene oxide) the novolac tends to flow more easily along the glass fibers.

Furthermore, in contrast to prior methods which use liquid resole, it is preferred to apply the solid novolak and curing agents in the form of a water slurry (not dissolved) which is sprayed into the glass at high velocity. When doing this, the glass acts more or less as a filter, and as such there is a tendency for particles to become preferentially trapped at intersection points due merely to physical means.

In sector 14 the mattress is brought to the melting temperature of the catalyst encapsulant (temperature >105° C.), thereby resulting in the resin cross-linking reaction taking place and the formation of a layer of hardened material, that mutually links the fibers at the fiber-fiber junctions, i.e., the knots, thus providing the compact structure 16 (FIG. 6). This structure is, therefore, only locally stiffened at the crossing points or knots between the fibers 8; i.e., where the molten phenol-formaldehyde resin accumulates due to the reduction of its surface tension.

In this way, it is possible to obtain a heat and acoustic insulating product 16 (FIG. 3) which, as opposed to those already known, is more resistant, easier to handle and does not generate the harmful scattering of hardened resin fragments into the environment.

In the phenol-formaldehyde resin a suitable cross-linking or curing agent is dispersed, in the form of an encapsulated powder, wherein the encapsulant has the property of melting or decomposing at a higher temperature than the melting temperature of the phenol-formaldehyde resin. The encapsulated curing agent has a mean particle diameter of 30 μm to 50 μm.

The high-molecular-weight novolak type substituted phenolic resin to be incorporated in the setting type resin composition of the present invention may be any of the conventional, substantially linear, high-molecular-weight novolak type substituted phenolic resin which comprises a constituent phenol component comprised mainly of a bifunctional phenol employed in the coating and construction arts. The high-molecular-weight novolak type substituted phenolic resin (hereinafter referred to as “high-molecular-weight novolak type resin”) used in the present invention may be comprised of novolak type recurring units, all of which are substantially linear or it may contain intervening or bridging groups consisting of a divalent hydrocarbon group, which appear alternately in blocks of the novolak type recurring units. By the term “substantially linear” used herein, it is meant that the molecular structure of the polymer is a linear structure including straight or branched chains but is substantially free of crosslinkages (gelled portions). Such novolak type resins are disclosed in U.S. Pat. No. 4,342,852 and others.

The typical high-molecular-weight novolak type substituted phenolic resins that may be employed in the practice of the invention generally comprise substantially linear novolak type recurring units formed by condensation of a phenol component containing 70 to 100 mole %, preferably 80 to 100 mole %, especially preferably 90 to 100 mole % of at least one bifunctional phenol represented by the following general formula [I]: (R¹)₃-Z(OH)—(R)₂ wherein Z(OH) is phenol; two of the three R¹'s are hydrogen atoms and the remaining R¹ is an alkyl group having 1 to 8 carbon atoms, an aryl group having 6 to 10 carbon atoms, a halogen atom or a hydroxyl group, preferably an alkyl group of 1 to 8 carbon atoms, especially preferably a substituent selected from methyl, ethyl, isopropyl, sec-butyl, tert-butyl and octyl groups, and the two R's, which may be the same or different, stand for a member selected from the group consisting of a hydrogen atom, an alkyl group having 1 to 8 carbon atoms, a halogen atom and a hydroxyl group. Preferably one of the two R's is a hydrogen atom and the remaining R is a hydrogen atom or an alkyl group having 1 to 8 carbon atoms. Especially preferred are phenols wherein both R's are hydrogen atoms, and up to 30 mole %, preferably up to 20 mole %, especially preferably up to 10 mole %, of a trifunctional phenol, with at least one aldehyde component represented by the following general formula [II]: R²—CHO, wherein R² stands for a hydrogen atom or a substituent selected from the group consisting of a methyl group and a halogenated methyl group, preferably a hydrogen atom or methyl group, especially preferably a hydrogen atom.

The novolak type recurring units constituting the high-molecular-weight novolak type resin form a substantially linear chain structure in which the above-mentioned hydroxyarylene units and alkylidene units are alternately arranged and connected with one another. More specifically, the structure of the novolak type recurring units constituting the high-molecular-weight novolak type resin is such that when the phenol is comprised solely of the bifunctional phenol represented by the general formula [I], the resin is linear and if the content of the trifunctional phenol is increased, the resin sometimes has a branched structure. The ratio of the aldehyde component to the total phenol component in the novolak type recurring units is such that the amount of the aldehyde component is ordinarily in the range of from 0.90 to 1.0 mole, preferably from 0.93 to 1.0 mole, per mole of the total phenol component. Ordinarily, the novolak type recurring units are free of a methylol group, but they may comprise a methylol group in a minute amount, for example, up to 0.01 mole per mole of the total phenol component.

In the phenol component in the novolak type recurring units constituting the high-molecular-weight novolak type resin (B), the bifunctional phenol is a phenol represented by the above general formula [I] having on the benzene nucleus two hydrogen atoms active to the substitution reaction. More specifically, the bifunctional phenol is a phenol of the general formula [I] which has an alkyl group having 1 to 8 carbon atoms, an aryl group having 6 to 10 carbon atoms, a halogen atom or a hydroxyl group at the ortho- or para-position to the hydroxyl group. For example, there can be mentioned ortho- and para-isomers of alkylphenols such as cresol, ethylphenol, n-propylphenol, isopropylphenol, n-butylphenol, sec-butylphenol, tert-butylphenol, sec-amylphenol, tert-amylphenol, hexylphenol, heptylphenol and octylphenol, halogenated phenols such as fluorophenol, chlorophenol and bromophenol, and arylphenols such as phenylphenol and tolylphenol. Furthermore, as the bifunctional phenol represented by the above general formula [I], there can be mentioned 2,3-xylenol, 3,4-xylenol, 2,5-xylenol, 2,3-diethylphenol, 3,4-diethylphenol, 2,5-diethylphenol, 2,5-diethylphenol, 2,3-diisopropylphenol, 3,4-diisopropylphenol, 2,5-diisopropylphenol, 2,3-dichlorophenol, 3,4-dichlorophenol, 2,5-dichlorophenol, 2-methyl-3-phenylphenol, 3-methyl-4-phenylphenol and 2-methyl-5-phenylphenol. The bifunctional phenol component in the novolak type recurring units constituting the high-molecular-weight novolak type resin (B) is at least one member selected from the above-mentioned phenols, and it may be a mixture of two or more of the foregoing phenols.

The trifunctional phenol which may be contained in the novolak type recurring units constituting the high-molecular-weight novolak type resin (B) is a phenol having on the benzene nucleus three hydrogen atoms active to the substitution reaction, and as such trifunctional phenol, there can be mentioned phenol, meta-substituted phenols and 3,5-substituted phenols. As substituents which such trifunctional phenol has at the meta- or 3,5-positions, there can be mentioned alkyl groups, halogen atoms and hydroxyl groups. Among these trifunctional phenols, those represented by the following general formula [III] are preferred: [R]₂ wherein R stands for a hydrogen atom, an alkyl group having 1 to 8 carbon atoms, a halogen atom or a hydroxyl group, and the two R's may be the same or different.

As specific examples, there can be mentioned phenol, meta-substituted phenols such as m-cresol, m-ethylphenol, m-n-propylphenol, m-isopropylphenol, m-n-butylphenol, m-sec-butylphenol, m-tert-butylphenol, m-n-amylphenol, m-sec-amylphenol, m-tert-amylphenol, m-hexylphenol, m-heptylphenol, m-octylphenol, m-fluorophenol, m-chlorophenol, m-bromophenol and resorcinol, and 3,5-di-substituted phenols such as 3,5-xylenol, 3,5-diethylphenol, 3,5-diisopropylphenol, 3,5-di-sec-butylphenol, 3,5-di-tert-butylphenol, 3,5-di-sec-amylphenol, 3,5-di-tert-amylphenol, 3,5-dihexylphenol, 3,5-diheptylphenol, 3,5-dioctylphenol, 3,5-dichlorophenol, 3,5-difluorophenol, 3,5-dibromophenol and 3,5-diiodophenol. Among these trifunctional phenols, those represented by the above-general formula [III] in which one of the two groups R is a hydrogen atom and the other group R is selected from a hydrogen atom, an alkyl group having 1 to 8 carbon atoms and a chlorine atom are especially preferred, and phenols in which one of the two groups R is a hydrogen atom and the other group R is a hydrogen atom, a methyl group, an isopropyl group, a sec-butyl group, a tert-butyl group or an octyl group are particularly especially preferred.

The aldehyde component in the novolak type recurring units constituting the high-molecular-weight novolak type resin (B) is an aldehyde represented by the above-mentioned general formula [II]. As such aldehyde, there can be mentioned, for example, formaldehyde, acetaldehyde, monochloroacetaldehyde, dichloroacetaldehyde and trichloroacetaldehyde. Among these aldehydes, formaldehyde and acetaldehyde, especially formaldehyde, are preferred. The aldehyde component is present in the high-molecular-weight novolak type substituted phenolic resin in the form of an alkylidene group represented by the general formula [V].

In the present invention, the novolak type recurring units (a) consisting of the above-mentioned phenol and aldehyde components, as pointed out hereinbefore, there may be contained intervening or bridging groups (also called “chain extender component units” hereinafter) consisting of a divalent hydrocarbon group, which appear alternately in blocks of the novolak type recurring units. The resin of this type is characterized in that the novolak type recurring unit blocks (a) having a relatively low molecular weight and the chain extender component units (b) are alternately arranged and connected to one another, whereby the molecular weight of the resin is increased, and that the novolak type recurring unit blocks (a) are bonded to terminals of the molecule of the resin. A simplest structure of the resin of this type comprises two molecules of the novolak type recurring unit blocks (a) connected to each other through one molecule of the chain extender component unit (b), and a simple structure next to the above-mentioned simplest structure comprises 3 molecules of the novolak type recurring unit blocks (a) and two molecules of the chain extender component units (b) which are alternately arranged and connected to one another. Furthermore, there can be mentioned a structure comprising 4 molecules of the novolak type recurring unit blocks (a) and 3 molecules of the chain extender component units (b) which are similarly alternately arranged and connected to one another, and a structure comprising n molecules of the novolak type recurring unit blocks (a) and (n−1) molecules of the chain extender component units (b) which are alternately arranged and connected to one another.

When the molecular weight of these chain extender component units (b) is too high, the melting point of the resulting high-molecular-weight novolak type substituted phenolic resin is reduced but the flexibility is increased. Therefore, even if such resin is incorporated in a setting type resin, there can hardly be obtained a setting resin composition excellent in the heat resistance and mechanical properties. Accordingly, it is preferred that the molecular weight of the chain extender component unit (b) be 14 to 200 and especially 14 to 170.

The high-molecular-weight novolak type resin used in the present invention is prepared according to a process comprising reacting (A) (i) a phenol comprised mainly of at least one bifunctional phenol represented by the general formula [I] or (ii) a novolak type substituted phenolic resin consisting of a phenol comprised mainly of said bifunctional phenol and an aldehyde represented by the following general formula [II], in the presence of an acid catalyst, so that at least 70 mole % of the phenol component in the final novolak, type substituted phenolic resin is occupied by said bifunctional phenol, until the number average molecular weight of the final novolak type substituted phenolic resin is at the desired level.

According to a preferred embodiment of the present invention, the cross-linking agent comprises a formaldehyde derivative, preferably hexamethylene tetramine (hexamine), whose grains are encapsulated in a material coating having a higher melting point or decomposition temperature than the phenol-formaldehyde resin. In place of hexamine, the following cross-linking or curing agents may also be used, all coated with a high fusing encapsulating material: paraformaldehyde, hexamethoxymelamine, trimellitic anhydride, epoxy resins, phenol resolic resins, melamine resins, pre-reacted epoxy-polyester resins.

The encapsulant is, preferably a copolymer of the propylene-ethylene-butadiene type.

The encapsulated curing agent is preferably contained in an amount from about 3% to 12% by weight with respect to the phenol-formaldehyde resin, and ordinarily has a melting temperature of at least 102° C.

Moreover, the use of encapsulated hexamethylentetramine or any of the other afore-mentioned encapsulating agents, may be extended to the so-called “pultrusions” (i.e. to drawing products) made of phenol-formaldehyde resins, for example, the grates and draw pieces used in “off-shore” platforms, and the like. Obviously, modifications may be made to the invention as above described and illustrated, in order to create variants thereof, which, however, will fall within the scope of the following claims. Thus, as an example, the glass fibers may be replaced with any other inorganic fiber of the type adapted to the purposes of the invention.

For maximum efficiency and effectiveness, the novolak (it being understood that the term, “novolac”, is intended to refer to any of the thermosetting resins embraced by the invention), in particulate form, e.g., powder, and encapsulated curing agent should be uniformly blended together such that the novolak is properly and thoroughly catalyzed upon heating and melting of the encapsulant in the intended application of the invention. If necessary, minor amounts of flow modifiers, such as fumed silica, alumina, or calcium stearate, may be added to ensure proper dispersion or to prevent premature agglomeration, sintering, or classification of the particles.

For applications such as molding powders, uniform and intimate contact between the novolak powder and the curing agent is easy to achieve, provided there is thorough pre-mixing of the components. However, in applications, such as fiberglass binding, it is possible that dilute phase dispersion of the two powders can allow the novolak and encapsulated curing agent to become significantly physically separated from each other such that the contact is not sufficiently intimate to promote efficient curing. In such cases, there are several ways of modifying the compounds or application techniques to substantially increase or preserve the contact between the novolak and curing agent. Such adhesion strengths do not necessarily need to be strong, yet the adhesive force must be sufficiently strong to preserve and maintain the contact after any mechanical processing associated with dispersion of the particles.

In addition, due consideration must be given to the relative particle sizes of the novolak and the encapsulated curing agent, such that the number and respective total mass of particles of curing agent adhering to an individual novolak particle corresponds on the average, as closely as possible, to the necessary weight ratio dictated in the overall formulation. Since the weight fraction of novolak to curing agent is typically about 9:1, this can be most practically accomplished by making the curing agent particles much smaller on the aveerage than the novolak particles.

In one embodiment, the contact can be provided by direct adhesion between the novolak and the encapsulating polymer. For example, a polyamide used for encapsulating the curing agent can be made by well-known methods employing the reaction of diamines or triamines (such as ethylenediamine or diethylenetriamine) and a dibasic acid, fatty acid or dimer acid. Polyamides of these types are commonly used in a wide variety of adhesive applications. By properly selecting the acid and amine, the polyamide can be varied from being very tacky at a given elevated temperature, yet at ambient temperatures can be a non-tacky, relatively high melting point resin. The degree of tackiness can also depend on the temperature arid composition of the polyamide, and in particular can be reflective of the glass transition properties of the polyamide. The glass transition point represents the point at which a polymer changes from a hard glassy state to a rubbery or tacky state.

If the polyamide has a minor degree of tackiness it can bond to the novolak particles whenever they are uniformly contacted with the encapsulated novolak in suitable equipment such as a fluid bed or flat belt whereupon the curing agent particles can be admixed or sprinkled onto dispersed novolak particles. This contacting would be effected at a temperature which can allow the surface of the encapsulant to become slightly tacky, yet the temperature would be below the melting or glass transition point of the novolak.

After contact and adhesion, it is then important that the tackiness be reduced so that gross agglomeration or fusion does not subsequently occur, which would then cause the mixture to lump up. This can most easily be accomplished merely by cooling the mixture, while in a fluidized or separated state, to a temperature substantially below the glass transition point of the polyamide. For example, if the novolak has a melting or glass transition point of 75° C., the polyamide can he selected to display a glass transition property of approximately 60° C. When contacted in the 60-75° C. range, the particles will adhere due to the tacky or rubbery state of the polyamide, but when subsequently cooled well below 60° C., the tackiness is avoided, yet the glass transition point of the polyamide is sufficiently high enough to prevent agglomeration during ordinary storage of the mixture prior to final applications. Any residual tackiness in the final product can be further minimized by adding inert inorganic fillers to the final product, such as talc, fumed silica, or the like,

Also, if the solvent used for encapsulation of the curing agent is not completely removed from the polyamide, such that the polyamide features some tackiness, and is subsequently contacted with the novolak, bonding will occur. Afterwards, the remaining solvent can be removed, such as in a separate step employing vacuum conditions to avoid temperatures which may melt the novolac. Fumed silica or other suitable additives may be additionally combined in the final step to effectively stick to residual tacky surfaces and thereby avoid lumping or agglomeration of the particles during storage of the product, or to enhance the free flow of the particles.

In another embodiment, a third binding ingredient may be added by uniform dispersion methods to the novolak and encapsulated curing agent mixture, such that weak, yet sufficient, bonding occurs between the particles. The levels of such a binder would by typically less than 5% of the total formulation. Examples of such third binder ingredients would be polyvinyl acetate emulsion, lignins, polyesters, and the like.

While this invention has been described in conjunction with specific embodiments thereof, it is evident that many alternatives, modifications and variations will be apparent to those skilled in the art. Accordingly, the preferred embodiments of the invention as set forth herein, are intended to be illustrative, no limiting. Various changes may be made without departing from the true spirit and full scope of the invention as set forth herein and defined in the claims.

What is claimed is:

1. A thermosetting resin composition comprising:
a particulate thermosetting phenol-aldehyde resin; and
a particulate curing agent for said thermosetting resin, said curing agent being encapsulated in a water insoluble thermoplastic resin having a softening point higher than, (1) the melting point of said thermosetting resin and, (2) the temperature at which said thermosetting resin flows on a solid substrate, said encapsulating thermoplastic resin also being dissolvable in said thermosetting resin by heating; said curing agent being capable of curing said thermosetting resin upon melting of said encapsulating thermoplastic resin and release thereof.

2. The thermosetting resin composition of claim 1 wherein said encapsulated curing agent comprises particles dispersed substantially homogeneously throughout said thermosetting resin.

3. The thermosetting resin composition according to claim 1, wherein said encapsulated curing agent is a microcapsule-type curing agent being an emulsion-type microcapsule curing agent formed from an emulsion containing said curing agent and said water insoluble thermoplastic resin as a particle material.

4. The thermosetting resin composition according to claim 1, wherein said encapsulated curing agent has a mean particle diameter in the range of 30 μm to 50 μm.

5. The thermosetting resin composition of claim 1 wherein said particulate thermosetting resin has a mean particle diameter in the range of 30 μm to 50 μm.

6. The thermosetting resin composition according to claim 1 wherein said thermoplastic encapsulating agent is a propylene/ethylene/butadiene block copolymer, polyamid, melamin, epoxy, polystrine spirene acrylic, glycidal and acrylic copolymer.

7. The thermosetting resin composition according to claim 1 wherein said curing agent is hexamethylentetramine, paraformaldehyde, hexamethoxymelamine, trimellitic anhydride, an epoxy resin, a phenol resolic resin, a melamine resin, a pre-reacted epoxy-polyester resin, mela-tripphenyl phosphine and quartenary ammoniumsall

8. The thermosetting resin composition according to claim 1 comprising a prepreg containing said thermosetting resin and said encapsulated curing agent.

9. The thermosetting resin composition of claim 1 wherein said phenol-aldehyde resin is a novolac.

10. The thermosetting resin composition of claim 1 wherein said phenol-aldehyde resin is a novolac having a molecular weight between about 300 and 2000.

11. The thermosetting resin composition of claim 1 wherein said phenol-aldehyde resin is a novolac formed by formed by condensation of a phenol component comprising at least one bifunctional phenol with at least one aldehyde component represented by the formula: R—CHO wherein R represents a hydrogen atom, a methyl group or a halogenated methyl group.

12. The thermosetting resin composition of claim 11 wherein said phenol-aldehyde resin is a phenol-formaldehyde resin.

13. The thermosetting resin composition of claim 1 wherein at least one particle of said particulate encapsulated curing agent is adhered to at least one particle of said thermosetting resin.

14. A curing agent for a thermosetting phenol-aldehyde resin, said curing agent being encapsulated in a water insoluble thermoplastic resin having a softening point higher than, (1) the melting point of said thermosetting resin and, (2) the temperature at which said thermosetting resin flows on a solid substrate, said encapsulating thermoplastic resin also being dissolvable in said thermosetting resin by heating; said curing agent being capable of curing said thermosetting resin upon melting of said encapsulating thermoplastic resin and release thereof.

15. The curing agent of claim 14 in particulate form.

16. The curing agent of claim 15 comprising particles having a mean particle diameter in the range of 30 μm to 50 μm.

17. The curing agent of claim 14 wherein said encapsulating curing agent is a microcapsule-type curing agent being an emulsion-type microcapsule curing agent formed from an emulsion containing said curing agent and said water insoluble thermoplastic resin as a particle material.

18. A method for curing a thermosetting phenol-aldehyde resin comprising contacting said resin with the curing agent of claim 14 and heating said resulting combination to a temperature above the melting point of said encapsulating thermoplastic resin.

19. The method of claim 18 wherein said thermosetting resin is in particulate form.

20. The method of claim 18 wherein said curing agent comprises particles substantially homogeneously distributed throughout said thermosetting resin.

21. The method of claim 18 wherein said curing agent comprises particles having a mean particle diameter in the range of 30 μm to 50 μm.

22. The method of claim 18 wherein said particulate thermosetting resin has a mean particle diameter in the range of 30 μm to 200 μm.

23. The method of claim 19 wherein at least one particle of said particulate encapsulated curing agent is adhered to at least one particle of said thermosetting resin.

24. The method of claim 18 wherein said combination is cured in the presence of a substrate that is substantially chemically inert with respect to said thermosetting resin and said curing agent.

25. The method of claim 24 resulting in the formation of a composite material comprising cured thermoset resin and said substrate.

26. The method of claim 25 wherein said composite comprises said substrate substantially surrounded by a matrix comprising said thermoset resin.

27. The method of claim 25 wherein said substrate is fiberglass.

28. A process for producing materials consisting of a mass of mutually linked inorganic fibers, comprising linking the fibers at localized fiber-fiber junctions or knots by distributing particles of a binding material and of a cross linking agent within the fiber mass and activating said binding material and cross linking agent be heating said material and agent to their respective melting temperatures, wherein said cross linking agent has a higher melting point than said binding material.

29. A process according to claim 28, wherein said binding material and said cross linking agent are in the form of a powder.

30. A process according to claim 28, wherein said binding material is in the form of an aqueous dispersion (slurry) of a phenolic resin.

31. A process according to claim 28, wherein said binding material consists of a phenolic resin and said cross linking consists of a derivative of formaldehyde coated with a film of material having a melting point higher than that of the phenolic resin.

32. A process according to claim 31, wherein said formaldehyde derivative consists of a hexamethylenetetramine powder encapsulated in a coating of a material having a higher melting point than the said phenolic resin, said coating comprising a block copolymer of the propylene-ethylene-butylene type.

33. A process according to claim 32, characterized in that said binding material consists of a phenolic resin and that said cross linking agent is chosen from among one or more of the following compounds:
paraformaldehyde
hexamethoxymelamine
trimellitic anhydride
epoxy resins
resol-type phenolic resins
melamine resins
prereacted epoxy-polyester resins.

34. Apparatus for producing a mass of mutually linked inorganic fibers comprising a first furnace for melting glass inorganic material, a die connected to said furnace for obtaining a flow of molten glass, a rotatable spinneret disposed to receive said flow and form a plurality of glass fibers passed through openings in the spinneret as it is rotated, flame deflectors disposed in the path of the fibers for directing heat on the fibers passed onto a conveyor belt disposed below the fibers and means adjacent the fibers for simultaneously dispersing a of binding material and a powdered cross linking agent within the mass formed by said fibers prior to the fibers being passed onto the conveyor belt.

35. Apparatus according to claim 34, characterized in that it also contains a second furnace for receiving the fibers on the conveyor belt and heating said fiber up to the melting temperature of said binding material and said cross linking agent, respectively.

36. Apparatus according to claim 35, wherein said second furnace comprises two sections through which said fibers pass, each said section adapted to operate at a different temperature, the second section having an operating temperature greater than the operating temperature of the first section.
